(19) United States
(12) Patent Application Publication
(10) Pub. No.: US 2021/0147584 A1
(43) Pub. Date: May 20, 2021

(54) RECYCLED RUBBER

(71) Applicant: INDUSTRIAL TECHNOLOGY RESEARCH INSTITUTE, Hsinchu (TW)

(72) Inventors: Yi-Ting WEI, Zhubei City (TW); Jyh-Horng WU, Kaohsiung City (TW); Yao-Zu WU, Tainan City (TW); Ming-Tsong LEU, Tainan City (TW)

(73) Assignee: INDUSTRIAL TECHNOLOGY RESEARCH INSTITUTE, Hsinchu (TW)

(21) Appl. No.: 16/718,487

(22) Filed: Dec. 18, 2019

(30) Foreign Application Priority Data
Nov. 18, 2019 (TW) 108141765

(51) Int. Cl. C08C 19/08; C08J 11/06; C08L 53/00; C08L 25/10; C08C 19/30; C08L 47/00; C08L 17/00

(52) U.S. Cl. CPC C08C 19/08; C08J 2447/00; C08L 53/005; C08L 25/10; C08C 19/30; C08L 47/00; C08L 17/00; C08J 2317/00; C08J 2353/02; C08J 2347/00; C08J 2325/10; C08J 2417/00; C08J 2425/10; C08J 2453/02; C08J 11/06

(57) ABSTRACT

Recycled rubber is provided, which is formed by depolymerizing 100 parts by weight of rubber and 0.5 to 10 parts by weight of modifier, wherein the modifier is formed by reacting (a) R¹-M, (b) double bond monomer, (c) ethylene sulfide, and (d) polymerization terminator, wherein R¹ is C₄-C₁₆ alkyl group, M is Li, Na, K, Ba, or Mg and (b) double bond monomer is 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, 4,5-diethyl-1,3-octadiene, styrene, 1-ethylene naphthalene, 3-methylstyrene, 3,5-diethylstyrene, 4-propylstyrene, 2,4,6-trimethylstyrene, 4-dodecylstyrene, 3-methyl-5-n-hexylstyrene, 4-phenylstyrene, 2-ethyl-4-benzylstyrene, 3,5-diphenylstyrene, 2,3,4,5-tetraethyl styrene, 3-ethyl-1-vinylnaphthalene, 6-isopropyl-1-vinylnaphthalene, 6-cyclohexyl-1-vinylnaphthalene, 7-dodecyl-2-vinylnaphthalene, α-methyl styrene, or a combination thereof.

### CROSS REFERENCE TO RELATED APPLICATIONS

The present application is based on, and claims priority from, Taiwan Application Serial Number 108141765, filed on Nov. 18, 2019, the disclosure of which is hereby incorporated by reference herein in its entirety.

### TECHNICAL FIELD

The technical field relates to recycled rubber, and in particular it relates to a modifier of recycled rubber.

### BACKGROUND

The best way of treating waste rubber is recycling and reproduction. However, the existing method of recycling and reproduction has poor quality, bad reproduction factory environment, and high energy consumption. Accordingly, a depolymerization modifier should be developed to reduce the energy used by the recycling process, enhance the rubber's reproduction quality, and increase the applicability of depolymerized rubber.

### SUMMARY

One embodiment of the disclosure provides recycled rubber, being formed by depolymerizing 100 parts by weight of rubber and 0.5 to 10 parts by weight of modifier, wherein the modifier is formed by reacting (a) R¹-M, (b) double bond monomer, (c) ethylene sulfide, and (d) polymerization terminator, wherein R¹ is C₄-C₁₆ alkyl group, M is Li, Na, K, Ba, or Mg and (b) double bond monomer is 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, 4,5-diethyl-1,3-octadiene, styrene, 1-ethylene naphthalene, 3-methylstyrene, 3,5-diethylstyrene, 4-propylstyrene, 2,4,6-trimethylstyrene, 4-dodecylstyrene, 3-methyl-5-n-hexylstyrene, 4-phenylstyrene, 2-ethyl-4-benzylstyrene, 3,5-diphenylstyrene, 2,3,4,5-tetraethyl styrene, 3-ethyl-1-vinylnaphthalene, 6-isopropyl-1-vinylnaphthalene, 6-cyclohexyl-1-vinylnaphthalene, 7-dodecyl-2-vinylnaphthalene, α-methyl styrene, or a combination thereof.

In some embodiments, (b) double bond monomer and (a) R1-M have a weight ratio of 100:0.01 to 100:5.

In some embodiments, (b) double bond monomer and (c) ethylene sulfide have a weight ratio of 100:1 to 100:5.

In some embodiments, (b) double bond monomer and (d) polymerization terminator have a weight ratio of 100:1 to 100:5.

In some embodiments, the modifier has a weight average molecular weight of 1000 to 400,000.

In some embodiments, the rubber includes poly(cis-1,3-butadiene) rubber, polystyrene-butadiene rubber, nitrile rubber, buna rubber, ethylene propylene rubber, butyl rubber, or a combination thereof.

In some embodiments, (b) double bond monomer is styrene.

In some embodiments, (b) double bond monomer is styrene and isoprene, and styrene and the isoprene are arranged in block or random.

In some embodiments, (b) double bond monomer is isoprene.

In some embodiments, the recycled rubber is further vulcanization crosslinked.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides recycled rubber being formed by depolymerizing 100 parts by weight of rubber and 0.5 to 10 parts by weight of modifier. If the amount of the modifier is too low, the depolymerization quality cannot be improved. If the amount of the modifier is too high, the depolymerization quality is good, but the depolymerization quality cannot be further enhanced after the modifier amount achieves a certain degree. For example, the waste rubber and the depolymerization agent (e.g. the modifier) can be mixed by any known method in this field, such as thermo-mechanical mixing. The thermo-mechanical mixing steps often include a mechanical process at a depolymerization temperature in a mixer or an extruder for a suitable period of time. The suitable period of time of the thermo-mechanical work may vary based on the operation conditions and volume and properties of the components. For example, the thermo-mechanical work period can be from 1 minute to 60 minutes. In one embodiment, the depolymerization temperature can be 120° C. to 350° C. If the depolymerization temperature is too low, the depolymerization period will be longer or even fail to depolymerize the rubber. If the depolymerization temperature is too high, over-depolymerization may be occurred, degrading the recycled rubber quality and thereby lowering the tensile strength and elongation rate of the recycled rubber.

In one embodiment, the modifier is formed by reacting (a) R¹-M, (b) double bond monomer, (c) ethylene sulfide, and (d) polymerization terminator. (a) R¹-M serves as initiator to polymerize (b) double bond monomer. R¹ is C₄-C₁₆ alkyl group, and M is Li, Na, K, Ba, or Mg. In one embodiment, (b) double bond monomer is 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, 4,5-diethyl-1,3-octadiene, styrene, 1-ethylene naphthalene, 3-methylstyrene, 3,5-diethylstyrene, 4-propylstyrene, 2,4,6-trimethylstyrene, 4-dodecylstyrene, 3-methyl-5-n-hexylstyrene, 4-phenylstyrene, 2-ethyl-4-benzylstyrene, 3,5-diphenylstyrene, 2,3,4,5-tetraethyl styrene, 3-ethyl-1-vinylnaphthalene, 6-isopropyl-1-vinylnaphthalene, 6-cyclohexyl-1-vinylnaphthalene, 7-dodecyl-2-vinylnaphthalene, α-methylstyrene, or a combination thereof. After the polymerization is performed for a period, (c) ethylene sulfide can be added to react. Finally, (d) polymerization terminator can be added to terminate the reaction to obtain the so-called modifier. In one embodiment, (d) polymerization terminator can be butylated hydroxytoluene (BHT), butylated hydroxy anisole (BHA), tert-butylhydroquinone (TBHQ), propyl gallate (PG), ethoxyquinoline (EQ), hydroxymethyldibutylphenol (HMBP), Trihydroxybutyrophenone (THBP), octyl gallate (OG), dodecyl gallate (DG), hexyl resorcinol (4-HR), or n-dihydroguaiac acid (NDGA). In some embodiments, (b) double bond monomer is styrene. In some embodiments, (b) double bond monomer is styrene and isoprene, and styrene and the isoprene are arranged in block or random. In some embodiments, (b) double bond monomer is isoprene.

In some embodiments, (b) double bond monomer and (a) R¹-M have a weight ratio of 100:0.01 to 100:5. In one embodiment, (b) double bond monomer and (a) R¹-M have a weight ratio of 100:1 to 100:5. The amount of (a) R¹-M is varied on the basis of the required molecular weight of the synthesized rubber polymer and the precise polymerization temperature used to synthesize the rubber. One skilled in the art can easily determine the precise amount of (a) R¹-M for a polymer with an expected molecular weight. If (a) R¹-M amount is too low, the reaction condition will be more rigorous, such as well-anhydrous solvent or reactor to prevent overly low yield (or even no reaction). If (a) amount is too high, the polymerization will produce a lot of heat, such that reaction will be very dangerous due to the reaction temperature being out of control. In some embodiments, (b) double bond monomer and (c) ethylene sulfide have a weight ratio of 100:1 to 100:5. If (c) ethylene sulfide amount is over the stoichiometry amount, it may increase the cost. However, (c) ethylene sulfide amount can be over the stoichiometry amount a bit in many conditions to ensure that each of the modifier molecules is functionalized without being influenced by water molecule. In some embodiments, (b) double bond monomer and (d) polymerization terminator have a weight ratio of 100:1 to 100:5. If (d) polymerization terminator amount is too low, the reaction will not be terminated. If (d) polymerization terminator amount is too high, the residual polymerization terminator will have a negative influence on the recycled rubber quality when the rubber is depolymerized thereafter.

In some embodiments, the modifier has a weight average molecular weight (Mw) of 1000 to 400000. In some embodiments, the modifier has a number average molecular weight (Mn) of 500 to 100000. If the molecular weight of the rubber is higher, the molecular weight of modifier should be higher. If Mw or Mn of the modifier is too low, the depolymerization of the vulcanized rubber will be very smelly. If Mw or Mn of the modifier is too high, the sulfur group content of the modifier will be too low, and the quality of the recycled rubber will be poor. In some embodiments, the modifier has polymer dispersity index (PDI, Mw/Mn) of 1.1 to 3.5. If the PDI of the modifier is too low, the processability of the recycled rubber will be poor, and the recycled rubber will be smelly. If the PDI of the modifier is too high, the quality of the recycled rubber will be poor.

In some embodiments, the rubber includes poly(cis-1,3-butadiene) rubber, polystyrene-butadiene rubber, nitrile rubber, buna rubber, ethylene propylene rubber, butyl rubber, or a combination thereof.

In some embodiments, the recycled rubber can be further vulcanization crosslinked. For example, sulfur or other crosslinker can be added as needed to crosslink the recycled rubber, such that the properties of the recycled rubber are further adjusted to meet product specifications.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Synthesis Example 1 (PSPISH-Block-High Mw)

7.5 g of styrene was dissolved in 20.0 mL of toluene, and 2.3 mL of n-butyl lithium (C₄H₉Li) was then added into the toluene solution to initiate polymerization at room temperature for 20 minutes. Subsequently, 9.8 g of isoprene was added into the above reaction, and reacted at room temperature for 120 minutes to form poly(styrene-b-isoprene) block copolymer. 4.8 mL of ethylene sulfide was added into the above reaction, and reacted at room temperature for 120 minutes. Finally, an isopropyl alcohol solution of butylated hydroxytoluene (BHT) (0.1 g/100 mL) serving as polymerization terminator was added into the above reaction, and reacted at room temperature for 5 minutes to terminate the reaction.

The crude product was added into a lot of distilled water, stirred for 1 hour, and then stood to separate into two layers. The upper layer was extracted, and distilled water was added to the upper layer to perform extraction 3 times to ensure that the salt in the upper layer was completely removed. The upper layer was dropwisely added into a lot of ethanol to precipitate solid. The solid was collected and put into a vacuum oven at 40° C. for 24 hours, thereby obtaining a pale yellow modifier. The modifier was analyzed by gel permeation chromatography (GPC) to measure its weight average molecular weight (Mw) of 306100, number average molecular weight (Mn) of 91150, and polymer dispersity index (PDI, Mw/Mn) of 3.36.

### Synthesis Example 2 (PSPISH-Block-Low Mw)

7.5 g of styrene was dissolved in 100.0 mL of toluene, and 2.3 mL of n-butyl lithium (C₄H₉Li) was then added into the toluene solution to initiate polymerization at room temperature for 10 minutes. Subsequently, 9.8 g of isoprene was added into the above reaction, and reacted at room temperature for 20 minutes to form poly(styrene-b-isoprene) block copolymer. 4.8 mL of ethylene sulfide was added into the above reaction, and reacted at room temperature for 20 minutes. Finally, an isopropyl alcohol solution of BHT (0.1 g/100 mL) serving as polymerization terminator was added into the above reaction, and reacted at room temperature for 5 minutes to terminate the reaction.

The crude product was added into a lot of distilled water, stirred for 1 hour, and then stood to separate into two layers. The upper layer was extracted, and distilled water was added to the upper layer to perform extraction 3 times to ensure that the salt in the upper layer was completely removed. The upper layer was dropwisely added into a lot of ethanol to precipitate solid. The solid was collected and put into a vacuum oven at 40° C. for 24 hours, thereby obtaining a pale yellow modifier. The modifier was analyzed by GPC to measure its Mw of 1140, Mn of 670, and PDI of 1.7.

### Synthesis Example 3 (PSPISH-Random)

30 g of styrene and 21 g of isoprene were dissolved in 20.0 mL of toluene, and 6.0 mL of n-butyl lithium (C₄H₉Li) was then added into the mixture solution of styrene and isoprene to initiate polymerization in ice bath for 20 minutes to form poly(styrene-isoprene) random copolymer. 0.6 mL of ethylene sulfide was added into the above reaction, and reacted at room temperature for 120 minutes. Finally, an isopropyl alcohol solution of BHT (0.1 g/100 mL) serving as polymerization terminator was added into the above reaction, and reacted at room temperature for 5 minutes to terminate the reaction.

The crude product was added into a lot of distilled water, stirred for 1 hour, and then stood to separate into two layers. The upper layer was extracted, and distilled water was added to the upper layer to perform extraction 3 times to ensure that the salt in the upper layer was completely removed. The upper layer was dropwisely added into a lot of ethanol to precipitate solid. The solid was collected and put into a vacuum oven at 40° C. for 24 hours, thereby obtaining a pale yellow modifier. The modifier was analyzed by GPC to measure its Mw of 19030, Mn of 14600, and PDI of 1.30.

### Synthesis Example 4 (PSSH)

25 g of styrene was dissolved in 40 mL of toluene, and 1.5 mL of n-butyl lithium (C₄H₉Li) was then added into the solution of styrene to initiate polymerization at room temperature for 150 minutes to form polystyrene. 1.3 mL of ethylene sulfide was added into the above reaction, and reacted at room temperature for 24 hours. Finally, an isopropyl alcohol solution of BHT (0.1 g/100 mL) serving as polymerization terminator was added into the above reaction, and reacted at room temperature for 5 minutes to terminate the reaction.

The crude product was added into a lot of distilled water, stirred for 1 hour, and then stood to separate into two layers. The upper layer was extracted, and distilled water was added to the upper layer to perform extraction 3 times to ensure that the salt in the upper layer was completely removed. The upper layer was dropwisely added into a lot of ethanol to precipitate solid. The solid was collected and put into a vacuum oven at 40° C. for 24 hours, thereby obtaining a white modifier. The modifier was analyzed by GPC to measure its Mw of 1245, Mn of 986, and PDI of 1.26.

### Synthesis Example 5 (PISH)

20 g of isoprene was added into a anhydrous rounded bottom bottle, and 6.0 mL of n-butyl lithium (C₄H₉Li) was then added into isoprene to initiate polymerization in a water bath for 60 minutes to form a polyisoprene random copolymer. 0.8 mL of ethylene sulfide was added into the above reaction, and reacted at room temperature for 120 minutes. Finally, an isopropyl alcohol solution of BHT (0.1 g/100 mL) serving as polymerization terminator was added into the above reaction, and reacted at room temperature for 5 minutes to terminate the reaction.

The crude product was added into a lot of distilled water, stirred for 1 hour, and then stood to separate into two layers. The upper layer was extracted, and distilled water was added to the upper layer to perform extraction 3 times to ensure that the salt in the upper layer was completely removed. The upper layer was dropwisely added into a lot of ethanol to precipitate solid. The solid was collected and put into a vacuum oven at 40° C. for 24 hours, thereby obtaining a pale yellow modifier. The modifier was analyzed by GPC to measure its Mw of 5665, Mn of 4304, and PDI of 1.30.

### Comparative Example 1-1

40 g of waste rubber (recycled from batch A of whole tire from minibus) was added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 20% (according to ASTM5667) and crosslink degree of 3.50 (according to ASTM 6814-02). 100 g of the sheet was vulcanization crosslinked according to JIS standard (JIS K6313-2012), and the vulcanization crosslinked sheet was analyzed to measure its tensile strength of 6.01 MPa and elongation rate of 74%.

### Comparative Example 1-2

40 g of waste rubber (similar to the waste rubber in Comparative Example 1-1) and 1 phr of BHT (serving as anti-oxidant) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 17% (according to ASTM5667) and crosslink degree of 2.97 (according to ASTM 6814-02). 100 g of the sheet was vulcanization crosslinked according to JIS standard (JIS K6313-2012), and the vulcanization crosslinked sheet was analyzed to measure its tensile strength of 7.63 MPa and elongation rate of 86%.

### Comparative Example 1-3

40 g of waste rubber (similar to the waste rubber in Comparative Example 1-1), 1 phr of BHT (serving as anti-oxidant), and 1 phr of 2-mercaptobenzimidazole (MMBI, 98%, commercially available from Aldrich, serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 8% (according to ASTM5667) and crosslink degree of 3.02 (according to ASTM 6814-02). 100 g of the sheet was vulcanization crosslinked according to JIS standard (JIS K6313-2012), and the vulcanization crosslinked sheet was analyzed to measure its tensile strength of 7.18 MPa and elongation rate of 101%.

### Example 1 (PSPISH-Block-High Mw)

40 g of waste rubber (similar to the waste rubber in Comparative Example 1-1), 1 phr of the modifier of Synthesis Example 1, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 9% (according to ASTM5667) and crosslink degree of 3.06 (according to ASTM 6814-02). 100 g of the sheet was vulcanization crosslinked according to JIS standard (JIS K6313-2012), and the vulcanization crosslinked sheet was analyzed to measure its tensile strength of 9.02 MPa and elongation rate of 126%.

### Example 2 (PSPISH-Block-Low Mw)

40 g of waste rubber (similar to the waste rubber in Comparative Example 1-1), 1 phr of the modifier of Synthesis Example 2, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 8% (according to ASTM5667) and crosslink degree of 3.08 (according to ASTM 6814-02). 100 g of the sheet was vulcanization crosslinked according to JIS standard (JIS K6313-2012), and the vulcanization crosslinked sheet was analyzed to measure its tensile strength of 8.22 MPa and elongation rate of 103%.

### Example 3 (PSPISH-Random)

40 g of waste rubber (similar to the waste rubber in Comparative Example 1-1), 1 phr of the modifier of Synthesis Example 3, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 6% (according to ASTM5667) and crosslink degree of 3.12 (according to ASTM 6814-02). 100 g of the sheet was vulcanization crosslinked according to JIS standard (JIS K6313-2012), and the vulcanization crosslinked sheet was analyzed to measure its tensile strength of 9.37 MPa and elongation rate of 89%.

### Example 4 (PSSH)

40 g of waste rubber (similar to the waste rubber in Comparative Example 1-1), 1 phr of the modifier of Synthesis Example 4, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 4% (according to ASTM5667) and crosslink degree of 3.7 (according to ASTM 6814-02). 100 g of the sheet was vulcanization crosslinked according to JIS standard (JIS K6313-2012), and the vulcanization crosslinked sheet was analyzed to measure its tensile strength of 8.29 MPa and elongation rate of 128%.

### Example 5 (PISH)

40 g of waste rubber (similar to the waste rubber in Comparative Example 1-1), 1 phr of the modifier of Synthesis Example 5, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 5% (according to ASTM5667) and crosslink degree of 3.17 (according to ASTM 6814-02). 100 g of the sheet was vulcanization crosslinked according to JIS standard (JIS K6313-2012), and the vulcanization crosslinked sheet was analyzed to measure its tensile strength of 8.77 MPa and elongation rate of 141%.

The properties of Comparative Examples 1-1 to 1-3 and Examples 1 to 5 are shown in Table 1.

TABLE 1

| | | | | | | Tensile | | Elongation | |
|---|---|---|---|---|---|---|---|---|---|
| | BHT | MMBI | Modifier | Solute | Crosslink | strength | Increase | rate | Increase |
| | (PHR) | (PHR) | (PHR) | content | degree | (MPa) | ratio | (%) | ratio |
| Comparative | 0 | 0 | 0 | 20% | 3.50 | 6.01 | 0 | 74 | 0 |
| Example 1-1 | | | | | | | | | |
| Comparative | 1 | 0 | 0 | 17% | 2.97 | 7.63 | 27% | 86 | 16% |
| Example 1-2 | | | | | | | | | |
| Comparative | 1 | 1 | 0 | 8% | 3.02 | 7.18 | 19% | 101 | 36% |
| Example 1-3 | | | | | | | | | |
| Example 1 | 1 | 1 | 1 | 9% | 3.06 | 9.20 | 53% | 142 | 92% |
| Example 2 | 1 | 1 | 1 | 8% | 3.08 | 8.22 | 37% | 103 | 39% |
| Example 3 | 1 | 1 | 1 | 6% | 3.12 | 9.37 | 56% | 89 | 20% |
| Example 4 | 1 | 1 | 1 | 4% | 3.78 | 8.29 | 38% | 128 | 73% |
| Example 5 | 1 | 1 | 1 | 5% | 3.17 | 8.77 | 46% | 141 | 91% |

As shown in Comparison of Table 1, the modifier in Example 1 may greatly enhance the tensile strength and elongation rate of the recycled rubber.

### Comparative Example 2-1

40 g of waste rubber (recycled from batch B of whole tire from minibus), 1 phr of diphenyl disulfide (DPDS, 99%, commercially available from Aldrich, serving as modifier), 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 20% (according to ASTM5667), crosslink degree of 3.48 (according to ASTM 6814-02), and decrosslink degree of 76.8% (according to ASTM 6814-02). 100 g of the sheet was vulcanization crosslinked according to JIS standard (JIS K6313-2012), and the vulcanization crosslinked sheet was analyzed to measure its tensile strength of 6.06 MPa and elongation rate of 98%.

### Comparative Example 2-2

40 g of waste rubber (recycled from batch B of whole tire from minibus), 1 phr of bis(2-benzamidophenyl) disulfide (PiTong 22, commercially available from ShunLi, serving as modifier), 1 phr of BHT (serving as anti-oxidant), and 1 phr of NIMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 20% (according to ASTM5667), crosslink degree of 3.183 (according to ASTM 6814-02), and decrosslink degree of 78.8% (according to ASTM 6814-02). 100 g of the sheet was vulcanization crosslinked according to JIS standard (JIS K6313-2012), and the vulcanization crosslinked sheet was analyzed to measure its tensile strength of 7.73 MPa and elongation rate of 103.17%.

### Example 6

40 g of waste rubber (recycled from batch B of whole tire from minibus), 1 phr of the modifier of Synthesis Example 1, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 17% (according to ASTM5667), crosslink degree of 3.03 (according to ASTM 6814-02), and decrosslink degree of 79.8% (according to ASTM 6814-02). 100 g of the sheet was vulcanization crosslinked according to JIS standard (JIS K6313-2012), and the vulcanization crosslinked sheet was analyzed to measure its tensile strength of 9.81 MPa and elongation rate of 122.37%.

The properties of Comparative Examples 2-1 and 2-2 and Example 6 are shown in Table 2.

TABLE 2

| | | | | | Tensile | | Elongation | |
|---|---|---|---|---|---|---|---|---|
| | Modifier | Solute | Crosslink | Decrosslink | strength | Increase | rate | Increase |
| | (PHR) | content | degree | degree | (MPa) | ratio | (%) | ratio |
| Comparative | DPDS | 20% | 3.48 | 76.8% | 6.06 | 0 | 97.99 | 0 |
| Example 2-1 | | | | | | | | |
| Comparative | PiTong 22 | 20% | 3.183 | 78.8 | 7.73 | 27.5% | 103.17 | 5.3% |
| Example 2-2 | | | | | | | | |
| Example 6 | Synthesis | 17% | 3.03 | 79.8 | 9.81 | 61.8% | 122.37 | 24.9% |
| | Example 1 | | | | | | | |

As shown in Comparison of Table 2, the modifier in Example 6 may greatly enhance the tensile strength and elongation rate of the recycled rubber compared to the commercially available modifiers.

### Comparative Example 3-1

40 g of waste rubber (recycled from cover tire from trunk) was added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 6% (according to ASTM5667), crosslink degree of 3.27 (according to ASTM 6814-02), and decrosslink degree of 81% (according to ASTM 6814-02). 100 g of the sheet was vulcanization crosslinked according to JIS standard (JIS K6313-2012), and the vulcanization crosslinked sheet was analyzed to measure its tensile strength of 5.99 MPa and elongation rate of 61%.

### Comparative Example 3-2

40 g of waste rubber (recycled from cover tire from trunk) and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 7% (according to ASTM5667), crosslink degree of 3.09 (according to ASTM 6814-02), and decrosslink degree of 82% (according to ASTM 6814-02). 100 g of the sheet was vulcanization crosslinked according to JIS standard (JIS K6313-2012), and the vulcanization crosslinked sheet was analyzed to measure its tensile strength of 9.65 MPa and elongation rate of 154%.

### Comparative Example 3-3

40 g of waste rubber (recycled from cover tire from trunk), 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 5% (according to ASTM5667), crosslink degree of 3.03 (according to ASTM 6814-02), and decrosslink degree of 83% (according to ASTM 6814-02). 100 g of the sheet was vulcanization crosslinked according to JIS standard (JIS K6313-2012), and the vulcanization crosslinked sheet was analyzed to measure its tensile strength of 9.93 MPa and elongation rate of 143%.

### Example 7

40 g of waste rubber (recycled from cover tire from trunk), 1 phr of the modifier of Synthesis Example 1, 1 phr of BHT (serving as anti-oxidant), and 1 phr of MMBI (serving as a vulcanization retarder) were added to a plastometer (plasti-corder PL2000) for being depolymerized at 210° C. and 70 rpm to obtain recycled rubber. The depolymerization was repeated 3 times to obtain about 120 g of the recycled rubber. The recycled rubber was refined by double rollers at 40° C. and 30 rpm for 8 minutes to obtain a sheet. 10 g of the sheet was sampled to measure its solute content of 6% (according to ASTM5667), crosslink degree of 2.62 (according to ASTM 6814-02), and decrosslink degree of 85% (according to ASTM 6814-02). 100 g of the sheet was vulcanization crosslinked according to JIS standard (JIS K6313-2012), and the vulcanization crosslinked sheet was analyzed to measure its tensile strength of 11.66 MPa and elongation rate of 124%.

The properties of Comparative Examples 3-1 to 3-3 and Example 7 are shown in Table 3.

TABLE 3

| | | | | | | Tensile | | Elongation | |
|---|---|---|---|---|---|---|---|---|---|
| | MMBI | BHT | Modifier | Solute | Crosslink | strength | Increase | rate | Increase |
| | (1PHR) | (1PHR) | (1PHR) | content | degree | (MPa) | ratio | (%) | ratio |
| Comparative | 0 | 0 | 0 | 6% | 3.27 | 5.99 | 0 | 67 | 0 |
| Example 3-1 | | | | | | | | | |
| Comparative | 1 | 0 | 0 | 7% | 3.09 | 9.65 | 61 | 154 | 198 |
| Example 3-2 | | | | | | | | | |
| Comparative | 1 | 1 | 0 | 5% | 3.03 | 9.93 | 66 | 143 | 113 |
| Example 3-3 | | | | | | | | | |
| Example 7 | 1 | 1 | 1 | 6% | 2.62 | 11.66 | 95 | 124 | 85 |

As shown in Comparison of Table 3, the modifier in Example 7 may greatly enhance the tensile strength and elongation rate of the recycled rubber compared to the commercially available modifiers.

As shown in Examples 1, 6, and 7, the modifier can be used in the same rubber type from different sources (Examples 1 and 6), and can be used in different rubber types (Examples 6 and 7).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. Recycled rubber, being formed by
depolymerizing 100 parts by weight of rubber and 0.5 to 10 parts by weight of modifier,
wherein the modifier is formed by reacting (a) R¹-M, (b) double bond monomer, (c) ethylene sulfide, and (d) polymerization terminator,
wherein R¹ is C₄-C₁₆ alkyl group, M is Li, Na, K, Ba, or Mg and (b) double bond monomer is 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, 4,5-diethyl-1,3-octadiene, styrene, 1-ethylene naphthalene, 3-methylstyrene, 3,5-diethylstyrene, 4-propylstyrene, 2,4,6-trimethylstyrene, 4-dodecylstyrene, 3-methyl-5-n-hexylstyrene, 4-phenylstyrene, 2-ethyl-4-benzylstyrene, 3,5-diphenylstyrene, 2,3,4,5-tetraethyl styrene, 3-ethyl-1-vinylnaphthalene, 6-isopropyl-1-vinylnaphthalene, 6-cyclohexyl-1-vinylnaphthalene, 7-dodecyl-2-vinylnaphthalene, α-methylstyrene, or a combination thereof.

2. The recycled rubber as claimed in claim 1, wherein (b) double bond monomer and (a) R¹-M have a weight ratio of 100:0.01 to 100:5.

3. The recycled rubber as claimed in claim 1, wherein (b) double bond monomer and (c) ethylene sulfide have a weight ratio of 100:1 to 100:5.

4. The recycled rubber as claimed in claim 1, wherein (b) double bond monomer and (d) polymerization terminator have a weight ratio of 100:1 to 100:5.

5. The recycled rubber as claimed in claim 1, wherein the modifier has a weight average molecular weight of 1000 to 400,000.

6. The recycled rubber as claimed in claim 1, wherein the rubber comprises poly(cis-1,3-butadiene) rubber, polystyrene-butadiene rubber, nitrile rubber, buna rubber, ethylene propylene rubber, butyl rubber, or a combination thereof.

7. The recycled rubber as claimed in claim 1, wherein (b) double bond monomer is styrene.

8. The recycled rubber as claimed in claim 1, wherein (b) double bond monomer is styrene and isoprene, and styrene and the isoprene are arranged in block or random.

9. The recycled rubber as claimed in claim 1, wherein (b) double bond monomer is isoprene.

10. The recycled rubber as claimed in claim 1, being further vulcanization crosslinked.
